(19) United States
(12) Patent Application Publication
(10) Pub. No.: US 2019/0009756 A1
(43) Pub. Date: Jan. 10, 2019

(54) System and Method for Itinerant Power Source for Vehicles

(71) Applicant: QUALCOMM Incorporated, San Diego, CA (US)

(72) Inventor: Paul JACOBS, La Jolla, CA (US)

(21) Appl. No.: 15/985,980

(22) Filed: May 22, 2018

Related U.S. Application Data
(60) Provisional application No. 62/530,360, filed on Jul. 10, 2017.

(51) Int. Cl. B60S 5/06; B60L 11/18

(52) U.S. Cl. CPC B60S 5/06; B60L 11/1862; B60L 11/1822; B60L 11/1824

(57) ABSTRACT

Systems, methods, and devices of various embodiments enable autonomous battery vehicles to provide electricity to an electric vehicle. Various embodiments may enable an autonomous battery vehicle to navigate to an electric vehicle, replace an internal battery of the electric vehicle with the autonomous battery vehicle, and provide electricity to the electric vehicle. In some embodiments, an autonomous battery vehicle may be configured to have a dedicated purpose of recharging and/or replacing batteries of electric vehicles. In this manner, an autonomous battery vehicle may in effect be a battery that propels (e.g., drives, flies, etc.) itself.

### RELATED APPLICATIONS

This application claims the benefit of priority to U.S. Provisional Patent Application 62/530,360 entitled “System and Method for Itinerant Power Source for Vehicles,” filed Jul. 10, 2017, the entire contents of which are hereby incorporated by reference for all purposes.

### BACKGROUND

Electric vehicles are gaining in popularity and pose a technical solution to reducing carbon dioxide emissions from transportation. While electric vehicle and battery technologies are advancing, the deployment of electric vehicles continues to be limited by the availability of charging stations.

### SUMMARY

Systems, methods, and devices of various embodiments include autonomous battery vehicles configured to provide electricity to an electric vehicle. Various embodiments may enable an autonomous battery vehicle to navigate to an electric vehicle and replace or recharge an internal battery of the electric vehicle. In some embodiments, an autonomous battery vehicle may be configured to have a dedicated purpose of recharging and/or replacing batteries of electric vehicles. In this manner, an autonomous battery vehicle may, in effect, be a battery that propels (e.g., drives, flies, etc.) itself, thereby providing an itinerant power source for electric vehicles. Thus, various embodiments provide autonomous battery vehicles that bring the charging system to electric vehicles, relieving the need to bring electric vehicles to the charging station, and enabling recharging of electric vehicles in remote locations.

Various embodiments include methods that may be implemented in a processor or processing device of an autonomous battery vehicle and that may include controlling one or more components of the autonomous battery vehicle to charge an electric vehicle. Various embodiments may include controlling a propulsion system of the autonomous battery vehicle to navigate the autonomous battery vehicle to an electric vehicle, controlling the propulsion system to replace a first battery of the electric vehicle with the autonomous battery vehicle, and controlling a battery of the autonomous battery vehicle to provide electricity to the electric vehicle. In some embodiments, replacement of the first battery of the electric vehicle may occur while the electric vehicle is moving or stationary. In some embodiments, the autonomous battery vehicle may be one of an aerial autonomous battery vehicle or a terrestrial autonomous battery vehicle. In some embodiments, the first battery of the electric vehicle may be another autonomous battery vehicle.

Some embodiments may further include determining whether an amount of charge remaining in the battery is within a recharge window, and requesting another autonomous battery vehicle to replace the autonomous battery vehicle in the electric vehicle in response to determining that the amount of charge remaining in the battery is within the recharge window. In some embodiments, the recharge window may be an amount of charge remaining in the battery sufficient to enable the propulsion system to navigate the autonomous battery vehicle to a recharging station. Some embodiments may further include controlling the propulsion system to decouple the autonomous battery vehicle from the electric vehicle in response to replacement by another autonomous battery vehicle being initiated.

Further embodiments may include an autonomous battery vehicle having a processor configured with processor executable instructions to perform operations of any of the methods summarized above. Further embodiments may include an autonomous battery vehicle having means for performing functions of any of the methods summarized above. Further embodiments may include a processing device configured for use in an autonomous battery vehicle and configured to perform operations of any of the methods summarized above

### BRIEF DESCRIPTION OF THE DRAWINGS

The accompanying drawings, which are incorporated herein and constitute part of this specification, illustrate example embodiments of the claims, and together with the general description given above and the detailed description given below, serve to explain the features of the claims.

FIG. 1 is a system block diagram of autonomous battery vehicles operating according to various embodiments.

FIG. 2 is a component block diagram illustrating components of an autonomous battery vehicle according to various embodiments.

FIG. 3 is a component block diagram illustrating components of an aerial autonomous battery vehicle according to various embodiments.

FIG. 4 is a component block diagram illustrating components of a terrestrial autonomous battery vehicle according to various embodiments.

FIG. 5 is a process flow diagram illustrating a method for providing a charge to an electric vehicle according to some embodiments.

FIG. 6 is a process flow diagram illustrating a method for recharging an autonomous battery vehicle according to some embodiments.

FIGS. 7A-7D are system block diagrams illustrating an example of replacing an internal battery of an electric vehicle in need of charging with a terrestrial autonomous battery vehicle according to some embodiments.

FIGS. 8A-8D are system block diagrams illustrating an example of replacing an internal battery of an electric vehicle in need of charging with an aerial autonomous battery vehicle according to some embodiments.

FIGS. 9A-9D are system block diagrams illustrating an example of recharging an autonomous battery vehicle according to some embodiments.

FIG. 10 is a component diagram of an example computing device suitable for use with various embodiments.

FIG. 11 is a component diagram of another example computing device suitable for use with various embodiments.

FIG. 12 is a component diagram of another example computing device suitable for use with various embodiments.

### DETAILED DESCRIPTION

Various embodiments will be described in detail with reference to the accompanying drawings. Wherever possible, the same reference numbers will be used throughout the drawings to refer to the same or like parts. References made to particular examples and implementations are for illustrative purposes, and are not intended to limit the scope of the claims.

As used herein, the term “computing device” refers to any one or all of cellular telephones, smart phones, personal or mobile multi-media players, personal data assistants (PDAs), laptop computers, personal computers, tablet computers, smart books, palm-top computers, wireless electronic mail receivers, multimedia Internet enabled cellular telephones, wireless robotic vehicle controllers, and similar personal electronic devices which include a programmable processor and memory and circuitry configured to perform operations as described herein.

Various embodiments are described herein using the term “server” to refer to any computing device capable of functioning as a server, such as a master exchange server, web server, document server, content server, or any other type of server. A server may be a dedicated computing device or a computing device including a server module (e.g., running an application that may cause the computing device to operate as a server). A server module (e.g., server application) may be a full function server module, or a light or secondary server module (e.g., light or secondary server application) that is configured to provide synchronization services among the dynamic databases on receiver devices. A light server or secondary server may be a slimmed-down version of server-type functionality that can be implemented on a receiver device thereby enabling it to function as an Internet server only to the extent necessary to provide the functionality described herein.

As used herein, the terms “robotic vehicle” and “drone” refer to one of various types of vehicles including an onboard computing device configured to provide some autonomous or semi-autonomous capabilities. Examples of robotic vehicles include but are not limited to: aerial vehicles, such as an unmanned aerial vehicle (UAV); ground vehicles (e.g., an autonomous or semi-autonomous car, a vacuum robot, etc.); water-based vehicles (i.e., vehicles configured for operation on the surface of the water or under water); space-based vehicles (e.g., a spacecraft or space probe); and/or some combination thereof. In some embodiments, the robotic vehicle may be manned. In other embodiments, the robotic vehicle may be unmanned. In embodiments in which the robotic vehicle is autonomous, the robotic vehicle may include an onboard computing device configured to maneuver and/or navigate the robotic vehicle without remote operating instructions (i.e., autonomously), such as from a human operator (e.g., via a remote computing device). In embodiments in which the robotic vehicle is semi-autonomous, the robotic vehicle may include an onboard computing device configured to receive some information or instructions, such as from a human operator (e.g., via a remote computing device), and autonomously maneuver and/or navigate the robotic vehicle consistent with the received information or instructions. In some implementations, the robotic vehicle may be an aerial vehicle (unmanned or manned), which may be a rotorcraft or winged aircraft. For example, a rotorcraft (also referred to as a multirotor or multicopter) may include a plurality of propulsion units (e.g., rotors/propellers) that provide propulsion and/or lifting forces for the robotic vehicle. A rotorcraft may include any number of rotors.

The term “autonomous battery vehicle” is used herein to refer to one of various types of vehicles that may include a battery configured to recharge or replace batteries of electric vehicles and that may not utilize onboard, human drivers or pilots. An autonomous battery vehicle may include an onboard computing device configured to operate the autonomous battery vehicle without remote operating instructions (i.e., autonomously), such as from a human operator or remote computing device. Alternatively, the onboard computing device may be configured to operate the autonomous battery vehicle with remote operating instructions or updates to instructions stored in a memory of the onboard computing device.

The autonomous battery vehicle may be propelled for movement in any of a number of ways. As examples, the autonomous battery vehicle may be an aerial vehicle or a terrestrial vehicle. As specific examples, the autonomous battery vehicle may be wheeled robotic vehicle configured to travel on paved roads in traffic, or an unmanned aerial robotic vehicle having a propulsion system including one or more propellers or jets that may provide propulsion and/or lifting forces for travel or movement. An autonomous battery vehicle may not be configured to carry passengers or other cargo. Rather, an autonomous battery vehicle may be configured to be dedicated to the purpose of recharging and/or replacing batteries of electric vehicles. Thus, an autonomous battery vehicle may in effect be a battery that propels (e.g., drives, flies, etc.) itself, thereby providing an itinerant power source for electric vehicles.

Electric vehicles, such as electric cars, are becoming more prevalent each year. Some of the largest hurdles to wide scale electric vehicle implementation include the limitations on the storage capacity of batteries used in electric vehicles, the scarcity of charging stations, and the relatively long time required to recharge vehicle batteries. Solutions are needed to better provide for the recharging and/or the replacement (e.g., swap-out) of electric vehicle batteries.

Various embodiments include improved systems and methods for recharging battery powered vehicles by using an autonomous battery vehicle. An autonomous battery vehicle may be an autonomous robotic vehicle configured to navigate to an electric vehicle in need of charging, and recharge or replace (i.e., swap-out) the battery in the electric vehicle. Thus, various embodiments enable recharging electric vehicles where the vehicles are (e.g., in a parking lot) instead of requiring electric vehicles to travel to places of recharging. An autonomous battery vehicle may be a wheeled vehicle (e.g., a small car) or an airborne vehicle (e.g., a drone, UAV, etc.). In some embodiments, the autonomous battery vehicle may be configured to recharge and/or replace (i.e., swap-out) the battery of electric vehicles while moving. The autonomous battery vehicle may use a portion of the charge in the battery for traveling to the electric vehicle in need of charging and returning to a recharging station.

Various embodiments include an autonomous battery vehicle configured to navigate to an electric vehicle, recharge or replace (e.g., swap-out) an internal battery of the electric vehicle, and return to a depot or recharging station to have its battery recharged or replaced to prepare for another recharging mission. In some embodiments, a battery vehicle may be configured to have a dedicated purpose of recharging and/or replacing batteries of electric vehicles. In this manner, an autonomous battery vehicle may, in effect, be a battery that propels (e.g., drives, flies, etc.) itself, thereby providing an itinerant power source for electric vehicles. Some embodiments include an autonomous battery vehicle configured to enable recharging or battery replacement of electric vehicle batteries while the electric vehicle is moving (e.g., driving along a roadway, etc.).

In some embodiments, an autonomous battery vehicle may include a battery and a propulsion system connected to the battery. The battery may provide electrical power to the propulsion system to enable the propulsion system to move the autonomous battery vehicle from one location to another location. Through the control of the propulsion system, the autonomous battery vehicle may be navigated from a depot or charging station to rendezvous with an electric vehicle in need of recharging. In some embodiments, the propulsion system may be any type propulsion system, such as a ground-based propulsion system (e.g., a wheel based system, a track based system, etc.), a flight based propulsion system (e.g., a propeller based system, a jet based system, etc.), etc.

In some embodiments, an autonomous battery vehicle may include a processor connected to the battery and the propulsion system. The battery may provide electrical power to the processor. The processor may be configured to monitor the battery, for example to determine an amount of charge remaining in the battery at a given time. In some embodiments, the processor may be configured with processor-executable instructions to control the propulsion system to navigate the autonomous battery vehicle from one location to another location.

In some embodiments, an autonomous battery vehicle may be configured to replace an electric vehicle's battery that is in need of charging. Upon rendezvousing with the electric vehicle, the autonomous battery vehicle may cooperate with the electric vehicle to swap out the discharged battery with a charged battery on/within the autonomous battery vehicle. In some embodiments, the battery compartment may be at least partially internal to the electric vehicle, and the autonomous battery vehicle and/or the electric vehicle may be equipped with lifting assemblies to remove a spent battery from the electric vehicle and install a fresh battery carried by the autonomous battery vehicle.

In some embodiments, the battery of the electric vehicle may be an autonomous battery vehicle, and the battery compartment may be a recessed area in the electric vehicle, such as an underside of the electric vehicle, roof of the electric vehicle, etc., sized to accommodate the autonomous battery vehicle. The electric vehicle may be configured so that its battery that is in need of charging can exit from a battery compartment of the electric vehicle, and a fresh battery from the autonomous battery vehicle may enter. In some embodiments, the electric vehicle may be configured to open and close a covering for the battery compartment to allow and/or prevent access to the battery compartment from outside the electric vehicle. In some embodiments, the autonomous battery vehicle may be configured to open and close a covering for the battery compartment to allow and/or prevent access to the battery compartment from outside the electric vehicle.

In some embodiments, the battery of the electric vehicle may be an autonomous battery vehicle, and the process of replacing the battery may involve the spent autonomous battery vehicle exiting a battery compartment of the electric vehicle and a fully charged autonomous battery vehicle entering the battery compartment and connecting to the electric vehicle. The spent autonomous battery vehicle may then navigate to a depot or charging station for recharging while the electric vehicle proceeds on its way. In some embodiments, the autonomous battery vehicle may connect to the electric vehicle via one or more wires or other type physical coupling (e.g., connection plates, plugs, tabs, etc.) and/or via one or more non-physical couplings (e.g., conductive connections, inductive connections, etc.) to power the electric vehicle. In some embodiments, power from the battery of the autonomous battery vehicle may be provided to the engines of the electric vehicle. In some embodiments, power from the battery of the autonomous battery vehicle may be provided to another battery of the electric vehicle.

In some embodiments, an autonomous battery vehicle may be configured to communicate with one or more electric vehicles, one or more other autonomous battery vehicles, and/or a recharging network of one or more recharging stations. For example, the autonomous battery vehicle may include one or more radio modules connected to the processor and configured to conduct wireless communications with one or more electric vehicles, one or more other autonomous battery vehicles, and/or a recharging network. As another example, the autonomous battery vehicle may be configured to establish a communication link (e.g., a wired connection or wireless connection (e.g., an inductive link, etc.)) with an electric vehicle while at least partially internal to the electric vehicle or with a recharging station to conduct communications with one or more electric vehicles, one or more other autonomous battery vehicles, and/or a recharging network via the linked electric vehicle or the linked recharging station.

In some embodiments, an autonomous battery vehicle within an electric vehicle may be configured to request replacement by another autonomous battery vehicle in response to determining that the amount of charge remaining in the battery of the autonomous battery vehicle currently within the electric vehicle is within a recharge window. A recharge window may be an amount of charge remaining in the battery of the autonomous battery vehicle that is sufficient to enable the autonomous battery vehicle currently to travel to a recharging station. In some embodiments, the autonomous battery vehicle currently within the electric vehicle may monitor the locations of one or more recharging stations and dynamically determine its recharging window based on the distance to the nearest recharging station. As an example, the autonomous battery vehicle may communicate with a recharging network and receive information regarding locations (e.g., global positioning system (GPS) coordinates, etc.) of nearby recharging stations, and use such information to determine distances from the autonomous battery vehicle's current location to one or more recharging stations. The autonomous battery vehicle may estimate the amount of energy needed to travel to a closest recharging station and may set the recharge window equal to a charge state that will supply the estimated amount of energy plus an additional safety margin. For example, the additional safety margin may be any amount of energy, such as an amount equal to the estimated amount of energy needed to power the electric vehicle at current speeds while waiting for a replacement autonomous vehicle to arrive. Alternatively, the additional safety margin may a fixed margin, such as ten percent of the estimated amount of charge needed to transit the distance to the closest recharging station, five percent of the estimated amount of charge needed to transit the distance to the closest recharging station, or any other amount of charge. An autonomous battery vehicle currently within an electric vehicle may request replacement by communicating directly with the recharging network and/or using communications systems of the electric vehicle.

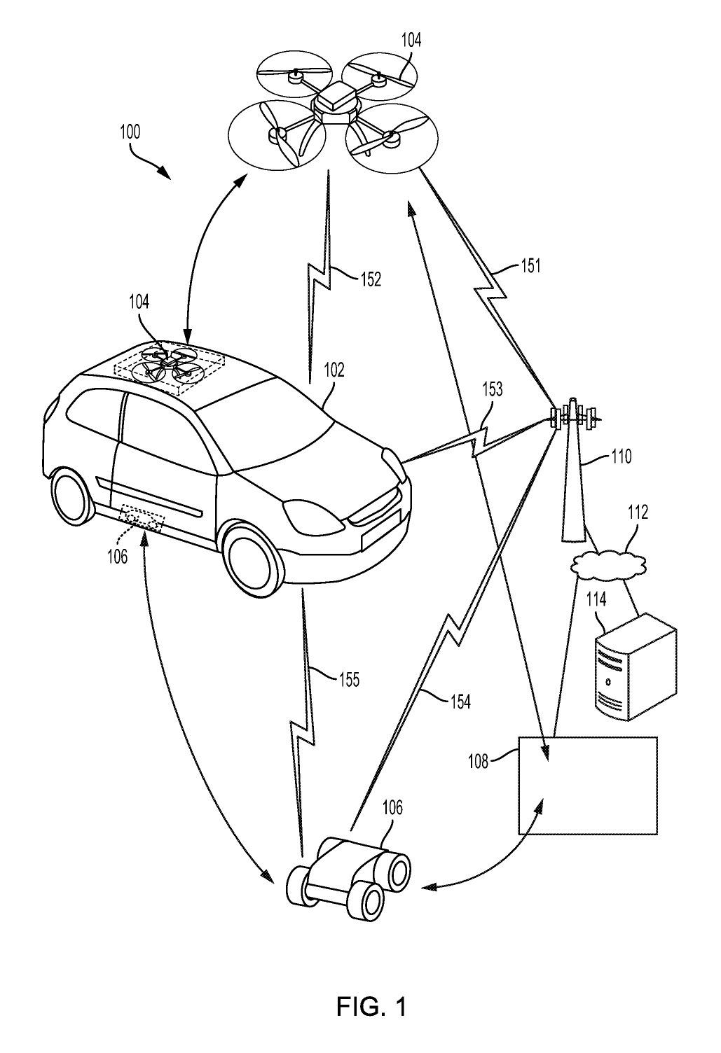

Various embodiments may be implemented within a communication system 100 of autonomous battery vehicles, electric vehicles, and recharging stations, an example of which is illustrated in FIG. 1. The system 100 may include one or more autonomous battery vehicles, such as autonomous battery vehicle 104 and autonomous battery vehicle 106, one or more electric vehicle, such as electric vehicle 102, one or more recharging station, such as recharging station 108, one or more base stations (or access points) 110, and one or more recharging system servers 114. The electric vehicle 102 may be any type electric vehicle, such as an electric car, plane, etc.

The base station 110 may include base stations configured to provide wireless communications over a wide area (e.g., macro cells), as well as small cells, which may include a micro cell, a femto cell, a pico cell, and other similar network access points. The base station 110 may be configured to provide wireless communications over a relatively smaller area. Other examples of base stations are also possible.

The autonomous battery vehicles 104, 106 may communicate with the electric vehicle 102 via one or more wireless communications links 152, 155, respectively. The autonomous battery vehicles 104, 106 may communicate with the base station 110 via one or more wireless communications links, 151, 154, respectively. The electric vehicle 102 may communicate with the base station 110 via one or more wireless communication links 153. Via various wireless communications links 151, 152, 153, 154, 155, the autonomous battery vehicles 104, 106, electric vehicle 102, and/or base station 110 may exchange data with one another.

The wireless communications links 151, 152, 153, 154, 155 may be direct (device-to-device) wireless links or may be wireless communication links established via various wireless network connections (e.g., cellular data networks, Wi-Fi wireless local area networks (WLAN), etc.).

The wireless communications links 151, 152, 153, 154, 155 may include a plurality of carrier signals, frequencies, or frequency bands, each of which may include a plurality of logical channels. The wireless communications links 151, 152, 153, 154, 155 may utilize one or more radio access technologies (RATs). Examples of RATs that may be used in a wireless communication link include Code Division Multiple Access (CDMA), Time Division Multiple Access (TDMA), Global System for Mobility (GSM), 3G, 4G, 5G, Long Term Evolution (LTE), and other cellular RATs. Further examples of RATs that may be used in one or more of the various wireless communications links 151, 152, 153, 154, 155 include medium range protocols such as Wi-Fi, LTE-U, LTE-Direct, LAA, MuLTEfire, and relatively short range RATs such as ZigBee, Bluetooth, and Bluetooth Low Energy (LE).

The base station 110, recharging station 108, and/or recharging system server 114 may connect to a communication network 112, such as the Internet, an LTE network, etc. Via the communication network 112, the recharging station 108, recharging system server 114, and/or base station 110 may communicate with the base station to exchange data with one another. Additionally, via the various wireless communications links 151, 152, 153, 154, 155, through the base station 110 and communication network 112, the autonomous battery vehicles 104, 106, electric vehicle 102, base station 110, recharging station 108, and/or recharging system server 114 may exchange data with one another. Data exchanged between the autonomous battery vehicles 104, 106, electric vehicle 102, base station 110, recharging station 108, and/or recharging system server 114 may include navigation information, battery charge state information, movement control instructions, and other information, instructions, or commands relevant to operations of the autonomous battery vehicles 104, 106, electric vehicle 102, base station 110, recharging station 108, and/or recharging system server 114.

The autonomous battery vehicles 104, 106 may be configured to navigate from one location to another location, such as between a recharging station 108 and the electric vehicle 102. As an example, an aerial autonomous battery vehicle 104 may fly from the recharging station 108 to the electric vehicle 102 and/or the autonomous battery vehicle 104 may fly from the electric vehicle 102 to the recharging station 108. As another example, a terrestrial autonomous battery vehicle 106 may drive from the recharging station 108 to the electric vehicle 102, and/or the autonomous battery vehicle 106 may drive from the electric vehicle 102 to the recharging station 108. Other example locations the autonomous battery vehicles 104, 106 may navigate to and form may include depots for repair and/or replacement of parts on the autonomous battery vehicles 104, 106, such as their respective batteries. In some embodiments, the autonomous battery vehicles 104, 106 may determine the location of the electric vehicle 102 and/or recharging station 108 based at least in part on communications from the electric vehicle 102 and/or recharging station 108. In some embodiments, the autonomous battery vehicles 104, 106 may determine the location of the electric vehicle 102 and/or recharging station 108 based at least in part on communications from the recharging system server 114.

The autonomous battery vehicles 104, 106 may be configured to charge or replace their batteries at the recharging station 108. The autonomous battery vehicles 104, 106 may connect to the recharging station 108 via one or more wires or other type physical coupling (e.g., connection plates, plugs, tabs, etc.) and/or via one or more non-physical couplings (e.g., conductive connections, inductive connections, etc.) to receive a charge from the recharging station 108. Additionally, via the one or more physical couplings and/or via the one or more non-physical couplings, the autonomous battery vehicles 104, 106 may communicate with the recharging station 108.

The autonomous battery vehicles 104, 106 may be configured to navigate to the electric vehicle 102 and replace an internal battery in need of charging with the autonomous battery vehicles 104, 106 themselves. For example, the aerial autonomous battery vehicle 104 may land in a battery compartment of the electric vehicle 102. As another example, a terrestrial autonomous battery vehicle 106 may drive into the battery compartment of the electric vehicle 102. A battery previously in the battery compartment before the autonomous battery vehicles 104, 106 arrived at the electric vehicle 102, such as another autonomous battery vehicle, may exit the battery compartment to enable the autonomous battery vehicles 104, 106 to enter the battery compartment. In some embodiments, the battery compartment may be at least partially internal to the electric vehicle 102. The battery compartment may be located anywhere on the electric vehicle 102, such as the roof, undercarriage, etc.

In response to the autonomous battery vehicle 104, 106 being inside the battery compartment, the battery of the autonomous battery vehicle 104, 106 may provide electricity to the electric vehicle 102. In some embodiments, the autonomous battery vehicle 104, 106 may connect to the electric vehicle 102 via one or more wires or other type physical coupling (e.g., connection plates, plugs, tabs, etc.) and/or via one or more non-physical couplings (e.g., conductive connections, inductive connections, etc.) to provide electricity to the electric vehicle 102. In some embodiments, electricity may be provided directly from the battery of the autonomous battery vehicle 104, 106 to an engine of the electric vehicle 102 and/or electricity may be provided to another battery of the electric vehicle 102. Additionally, via the one or more physical couplings and/or via the one or more non-physical couplings, the autonomous battery vehicles 104, 106 may communicate with the electric vehicle 102.

In some embodiments, the autonomous battery vehicles 104, 106 may communicate directly with the electric vehicle 102 to support charging of the electric vehicle 102. For example, the autonomous battery vehicles 104, 106 and electric vehicle 102 may communicate to indicate that the electric vehicle 102 is in need of a charge and that the autonomous battery vehicles 104, 106 are in route. In some embodiments, the autonomous battery vehicles 104, 106 may communicate with the electric vehicle 102 via the recharging system server 114. For example, the recharging system server 114 may direct the autonomous battery vehicles 104, 106 to the electric vehicle 102 in need of charging. Combinations of direct and indirect communications between the electric vehicle 102 and the autonomous battery vehicles 104, 106 may also be used in some embodiments.

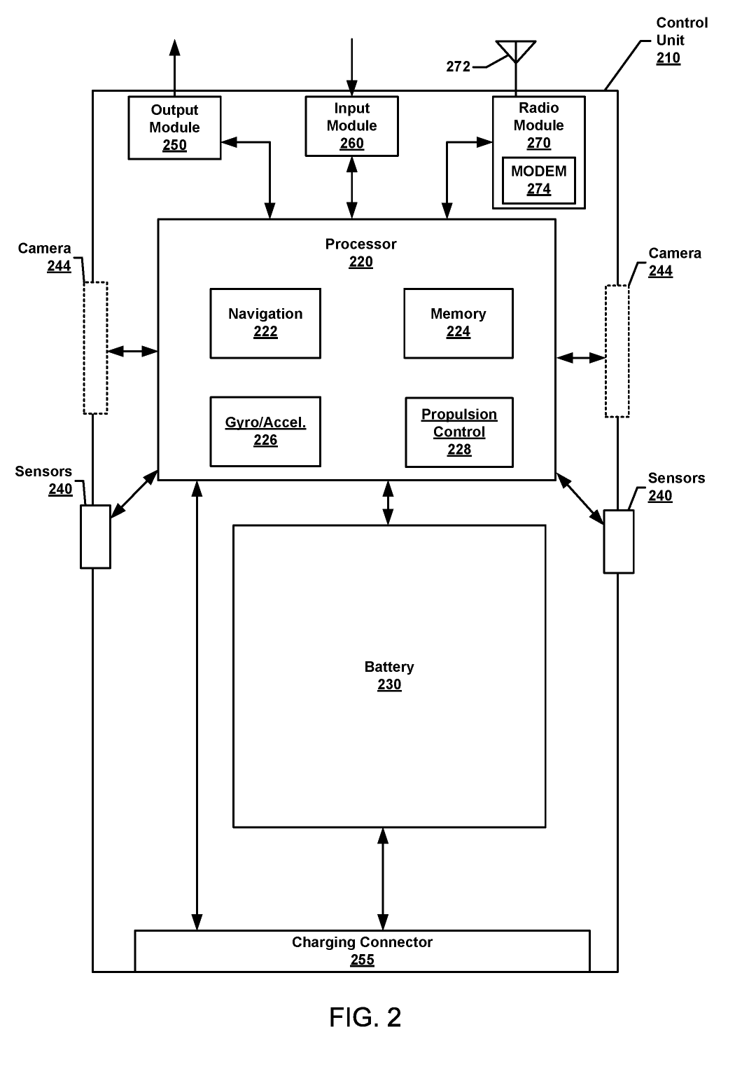

FIG. 2 illustrates an example of a control unit 210 of an autonomous battery vehicle (e.g., autonomous battery vehicles 104, 106). With reference to FIGS. 1 and 2, the control unit 210 may house various circuits and devices used to power and control the operation of the autonomous battery vehicle. The control unit 210 may include a processor 220, a battery 230, sensors 240, one or more cameras 244, an output module 250, an input module 260, a radio module 270, and a charging connector 255. The battery 230, sensors 240, one or more cameras 244, output module 250, input module 260, charging connector 255, and/or radio module 270, may be connected to the processor 220.

The processor 220 may be configured with processor-executable instructions to control travel and other operations of the autonomous battery vehicle, including operations of various embodiments. The processor 220 may include or be coupled to a navigation unit 222, a memory 224, a gyro/accelerometer unit 226, and a propulsion control module 228. The processor 220 and/or the navigation unit 222 may be configured to communicate with another computing device (e.g., electric vehicle 102, base station 110, recharging station 108, etc.) through wireless communications links, such as wireless communications links 151, 152, 154, 155.

The propulsion control module 228 may be coupled to the processor 220 and/or the navigation unit 222, and may be configured to provide travel control-related information such as altitude, attitude, airspeed, ground speed, heading, and similar information that the navigation unit 222 may use for navigation purposes, such as dead reckoning between Global Navigation Satellite System (GNSS) position updates. The gyro/accelerometer unit 226 may include an accelerometer, a gyroscope, an inertial sensor, or other similar sensors. The propulsion control module 228 may include or receive data from the gyro/accelerometer unit 226 that provides data regarding the orientation and accelerations of the autonomous battery vehicle that may be used in navigation and positioning calculations, as well as providing data used in various embodiments.

The processor 220 may further receive additional information from the sensors 240, such as an image sensor or optical sensor (e.g., a sensor capable of sensing visible light, infrared, ultraviolet, and/or other wavelengths of light). The sensors 240 may also include a radio frequency (RF) sensor, a barometer, a humidity sensor, a sonar emitter/detector, a radar emitter/detector, a microphone or another acoustic sensor, a lidar sensor, a time-of-flight (TOF) 3-D camera, or another sensor that may provide information usable by the processor 220 for movement operations, navigation and positioning calculations, determining environmental conditions, and/or entering or exiting the battery compartment of an electric vehicle (e.g., electric vehicle 102). The sensors 240 may also include one or more sensors configured to detect temperatures generated by one or more autonomous battery vehicle components, such as thermometers, thermistors, thermocouples, positive temperature coefficient sensors, and other sensor components.

The battery 230 may include one or more rechargeable and/or replaceable batteries that may provide power to various components, including the processor 220, the sensors 240, the one or more cameras 244, the output module 251, the input module 260, the one or more charging connectors 255, and the radio module 270. Additionally, the battery 230 may be connected to the propulsion system of the autonomous battery vehicle (e.g., connected to one or more motors of the propulsion system to power the motors). The processor 220 may be configured with processor-executable instructions to control the charging/discharging of the battery 230 (i.e., the storage or release of harvested energy), such as by executing a charging control algorithm using a charge control circuit. Alternatively or additionally, the battery 230 may be configured to manage its own charging. The battery 230 and processor 220 may be connected to a charging connector 255. The charging connector 255 may enable the battery 230 to connect to a recharging station (e.g., recharging station 108) and/or an electric vehicle (e.g., electric vehicle 102) to provide/receive electrical charge to/from the battery 230. The charging connector 255 may be a physical coupling connector (e.g., connection plate, plug, tab, etc.) and/or may be a non-physical coupling connector (e.g., conductive coil, inductive coil, etc.) that enables a connection to a recharging station (e.g., recharging station 108) and/or an electric vehicle (e.g., electric vehicle 102).

In some embodiments, the battery 230 that powers various components of the autonomous battery vehicle may be the same battery or batteries used to recharge or replace the batteries of an electric vehicle. In some embodiments, the battery 230 that powers various components of the autonomous battery vehicle may be separate and independent from the battery or batteries used to recharge or replace the batteries of an electric vehicle. In some embodiments, the battery 230 may be coupled to and receive power from the battery or batteries used to recharge or replace the batteries of an electric vehicle.

The processor 220 may be coupled to the output module 250, which may output control signals for managing the propulsion system (e.g., managing the motors) and other components (such as components not connected directly to the processor 220).

The processor 220 of the autonomous battery vehicle may control the propulsion system, such as controlling individual motors to enable the autonomous battery vehicle to perform maneuvers. The processor 220 may receive data from the navigation unit 222 and use such data to determine the present position and orientation of the autonomous battery vehicle, as well as the appropriate course towards the destination (e.g., an electric vehicle, a charging station, depot, etc.). In various embodiments, the navigation unit 222 may include a GNSS receiver system (e.g., one or more GPS receivers) enabling the autonomous battery vehicle to navigate using GNSS signals. Alternatively or in addition, the navigation unit 222 may be equipped with radio navigation receivers for receiving navigation beacons or other signals from radio nodes, such as navigation beacons (e.g., very high frequency (VHF) omni-directional range (VOR) beacons), Wi-Fi access points, cellular network sites, radio station, remote computing devices, other autonomous battery vehicles, etc.

The radio module 270 may be configured to receive navigation signals, such as signals from aviation navigation facilities, highway navigation facilities, etc., and provide such signals to the processor 220 and/or the navigation unit 222 to assist in autonomous battery vehicle navigation. In some embodiments, the navigation unit 222 may use signals received from recognizable RF emitters (e.g., AM/FM radio stations, Wi-Fi access points, and cellular network base stations) on the ground.

The navigation unit 222 may include a planning application that may perform calculations to plan a path of motion (“path planning”) for the autonomous battery vehicle. In some embodiments, the planning application may perform path planning using information including information regarding locations of the autonomous battery vehicle, an electric vehicle in need of recharging, and/or charging stations. The planning application may also consider environmental conditions, an amount of heat that may be generated by one or more components of the autonomous battery vehicle, a state of charge of the battery 230, etc.

The radio module 270 may include a modem 274 and a transmit/receive antenna 272. The radio module 270 may be configured to conduct wireless communications with a variety of wireless communication devices, examples of which include a wireless telephony base station or cell tower, a network access point, a beacon, and electric vehicle, a recharging station, a smartphone, a tablet, a laptop, or another computing device with which the autonomous battery vehicle may communicate. As specific examples, a wireless communication device may be the recharging station 108 and/or the electric vehicle 102. The processor 220 may establish a bi-directional wireless communication link via the modem 274 and the antenna 272 of the radio module 270 with a wireless communication device. In some embodiments, the radio module 270 may be configured to support multiple connections with different wireless communication devices using different radio access technologies.

In some embodiments, a wireless communication device may be connected to a server, such as a recharging system server 114, through intermediate access points. In some embodiments, the autonomous battery vehicle 104, 106 may include and employ other forms of radio communication, such as mesh connections with other autonomous battery vehicles or connections to other information sources (e.g., balloons or other stations for collecting and/or distributing weather or other data harvesting information).

In various embodiments, the control unit 210 may be equipped with an input module 260, which may be used for a variety of applications. For example, the input module 260 may receive images or data from an onboard camera 244 or sensors 240, or may receive electronic signals from other components.

While various components of the control unit 210 are illustrated as separate components, some or all of the components (e.g., the processor 220, the output module 250, the radio module 270, and other units) may be integrated together in a single device or module, such as a system-on-chip module.

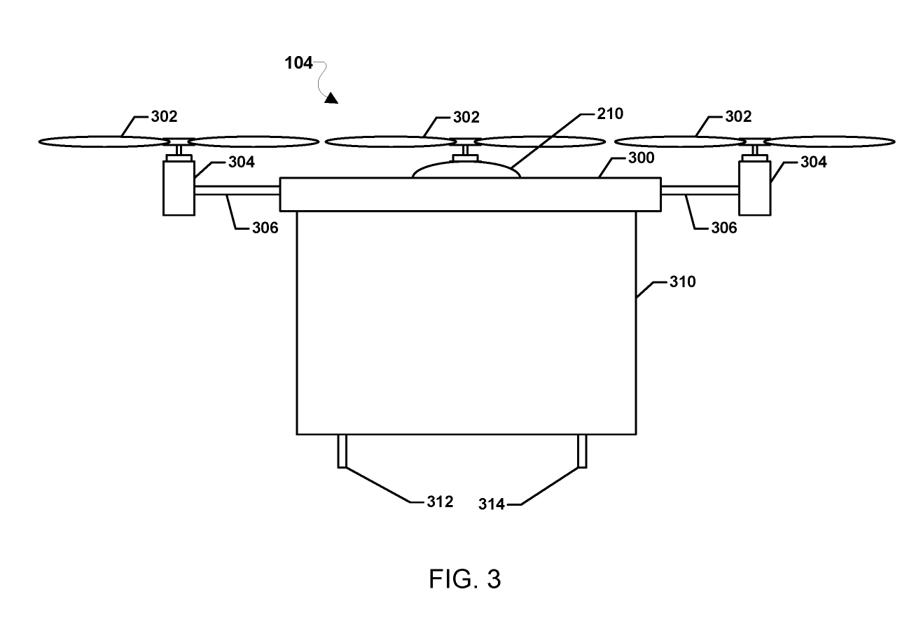

Autonomous battery vehicles may be various varieties of aerial or terrestrial autonomous battery vehicles. FIG. 3 illustrates an example of an aerial autonomous battery vehicle 104 according to various embodiments that utilizes multiple rotors 302 driven by corresponding motors to provide lift-off (or take-off) as well as other aerial movements (e.g., forward progression, ascension, descending, lateral movements, tilting, rotating, etc.). The autonomous battery vehicle 104 is illustrated as an example of an autonomous battery vehicle that may utilize various embodiments, but is not intended to imply or require that various embodiments are limited to aerial autonomous battery vehicles or rotorcraft autonomous battery vehicles. Various embodiments may be used with winged autonomous battery vehicles, land-based autonomous battery vehicles, water-borne autonomous battery vehicles, space-based autonomous battery vehicles, etc.

With reference to FIGS. 1-3, an aerial autonomous battery vehicle 104 may include a frame 300 coupled to a battery 310 sized and configured to recharge or replace a battery in an electric vehicle. The frame 300 may be connected to a number of propulsion modules that include propellers 302 powered by motors 304 (e.g., electric motors) suspended on an arm 306 connected to the frame. Flight of the aerial autonomous battery vehicle 104 may be controlled by a control unit 210 that is configured to control the power to and rotation rates of the motors 304 to affect lift and attitude control. The aerial autonomous battery vehicle 104 may include power connectors 312 and data link connectors 314 configured to make electrical power and data bus connections with an electric vehicle. In some embodiments, power connectors 312 and data link connectors 314 configured to serve as landing pads. For ease of description and illustration, some detailed aspects of the aerial autonomous battery vehicle 104 are omitted such as wiring, frame structure interconnects, or other features that would be known to one of skill in the art. While the illustrated aerial autonomous battery vehicle 104 has three propellers 302, this is merely exemplary and various embodiments may include any number of propellers 302.

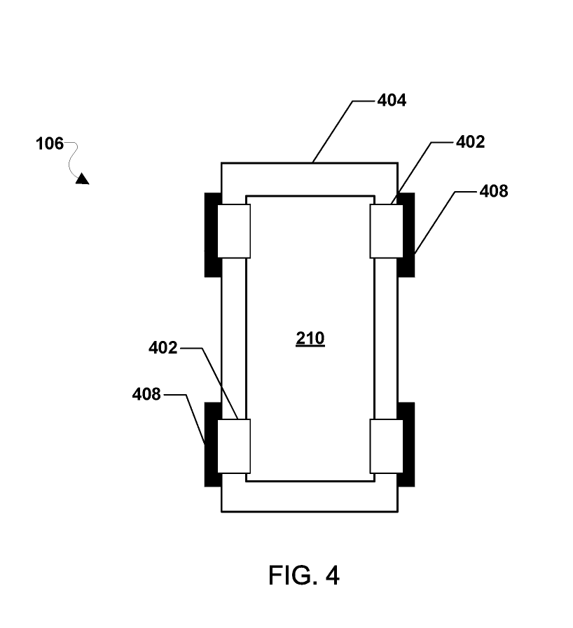

FIG. 4 illustrates an example of a terrestrial autonomous battery vehicle 106 according to various embodiments that utilizes multiple wheels 408 driven by corresponding motors 402 to provide locomotion as well as other driving movements (e.g., left/right steering, stopping, reverse, etc.). The terrestrial autonomous battery vehicle 106 is illustrated as an example of an autonomous battery vehicle that may utilize various embodiments, but is not intended to imply or require that various embodiments are limited to terrestrial autonomous battery vehicle 106 or wheeled autonomous battery vehicles. Various embodiments may be used with aerial autonomous battery vehicles, water-borne autonomous battery vehicles, space-based autonomous battery vehicles, etc.

With reference to FIGS. 1-4, the terrestrial autonomous battery vehicle 106 may include a number of motors 402, a number of wheels 408, a frame 404, and control unit 210. The frame 404 may provide structural support for the motors 402 associated with the wheels 408. Wheels 408 may support the maximum load weight for the combination of the components of the terrestrial autonomous battery vehicle 106. The motors 402 and associated wheels 408 may represent the propulsion system of the terrestrial autonomous battery vehicle 106. For ease of description and illustration, some detailed aspects of the terrestrial autonomous battery vehicle 106 are omitted such as wiring, frame structure interconnects, or other features that would be known to one of skill in the art. While the illustrated terrestrial autonomous battery vehicle 106 has four wheels 408, this is merely exemplary and various embodiments may include more or fewer than four wheels 408. As described with reference to FIG. 2, the control until 210 may output control signals for managing the motors 402 driving the wheels 408 to navigate the terrestrial autonomous battery vehicle 106 and otherwise control the physical actions of the terrestrial autonomous battery vehicle 106.

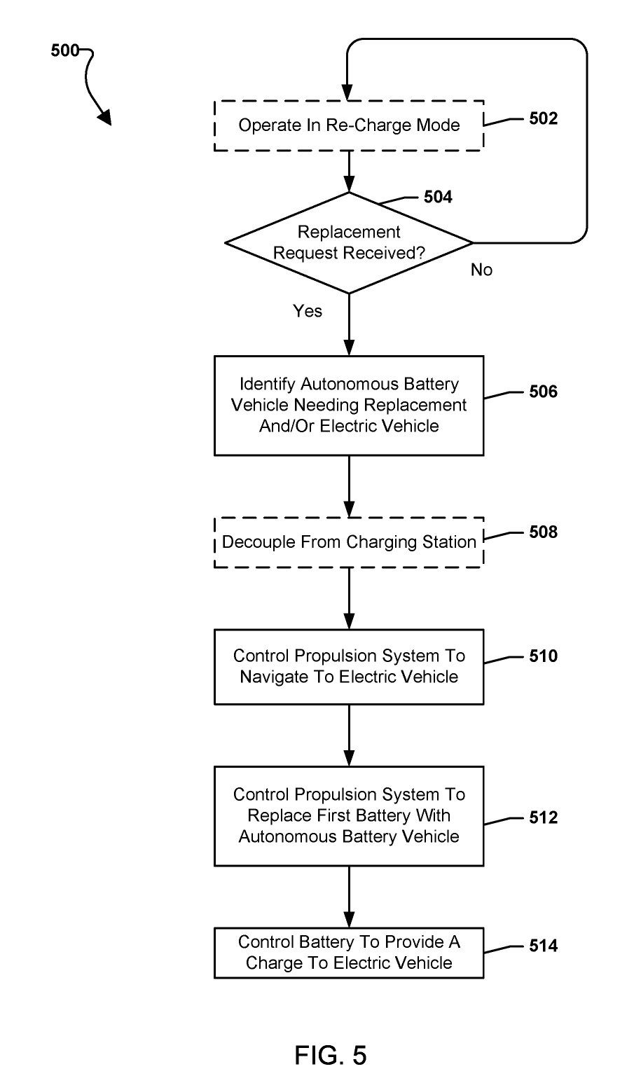

FIG. 5 illustrates a method for providing a charge to an electric vehicle according to some embodiments. With reference to FIGS. 1-5, the method 500 may be implemented in hardware components and/or software components of an autonomous battery vehicle (e.g., autonomous battery vehicle 104, 106), the operation of which may be controlled by one or more processors (e.g., the processor 220 and/or the like) of the autonomous battery vehicle.

In optional block 502, the autonomous battery vehicle processor may operate in a re-charge mode. For example, the autonomous battery vehicle may control the battery of the autonomous battery vehicle to draw a charge from a recharging station (e.g., recharging station 108). Block 502 may be optional as the battery may be fully charged and/or the autonomous battery vehicle need not be located at a charging station to perform other operations of method 500.

In determination block 504, the processor may determine whether a replacement request is received. A replacement request may be a message indicating that an electric vehicle (e.g., electric vehicle 102) internal battery is in need of charging and/or otherwise in need of replacement (or swap-out) (e.g., damaged, etc.). A replacement request may identify the electric vehicle in need of charging, identify an autonomous battery vehicle in need of replacement (or swap-out), and/or identify the location of the electric vehicle. In some embodiments, a replacement request may be received directly from an electric vehicle. In some embodiments, a replacement request may be received from a recharging system server (e.g., recharging system server 114). In some embodiments, a replacement request may be received from another autonomous battery vehicle, such as the autonomous battery vehicle currently providing a charge to the electric vehicle. In response to determining that a recharging request is not received (i.e., determination block 504=“No”), the autonomous battery vehicle processor may continue to operate in recharge mode in optional block 502 and/or continue to determine whether a replacement request is received in determination block 504.

In response to determining that a replacement request is received (i.e., determination block 504=“Yes”), the autonomous battery vehicle processor may identify the autonomous battery vehicle needing replacement (or swap-out) and/or the electric vehicle in block 506. For example, the replacement message may identify the electric vehicle in need of charging, identify an autonomous battery vehicle in need of replacement (or swap-out), and/or identify the location of the electric vehicle. As another example, the autonomous battery vehicle may request the identities and/or locations from a recharging system server 114.

In optional block 508, the autonomous battery vehicle processor may decouple the autonomous battery vehicle from the charging station. For example, the autonomous battery vehicle processor may control the motors of the autonomous battery vehicle to lift off or drive the autonomous battery vehicle off the recharging station. Block 508 may be optional as the autonomous battery vehicle need to be located at a charging station to perform other operations of method 500.

In block 510, the autonomous battery vehicle processor may control the propulsion system to navigate to the electric vehicle, such as the electric vehicle in need of charging, the electric vehicle associated with the autonomous battery vehicle needing replacement (or swap-out), etc. For example, the autonomous battery vehicle processor may control the motors of the autonomous battery vehicle to fly or drive the autonomous battery vehicle to the location of the electric vehicle. While the autonomous battery vehicle is transiting to the electric vehicle, the electric vehicle may periodically communicate its updated location information (e.g., GPS coordinates) to the autonomous battery vehicle. In this manner, even though the electric vehicle may be moving, the autonomous battery vehicle may be enabled to navigate to the autonomous battery vehicle.

In block 512, the autonomous battery vehicle processor may control the propulsion system to replace an internal first battery with the autonomous battery vehicle. For example, the discharged battery may exit a battery compartment of the electric vehicle. In some embodiments, the first battery may be an internal battery in need of charging of the electric vehicle. In some embodiments, the first battery may be another autonomous battery vehicle. In some embodiments, the battery compartment may be at least partially internal to the electric vehicle. As an example, the battery compartment may be a recessed area in the surface of the electric vehicle sized to accommodate the autonomous battery vehicle. In some embodiments, the electric vehicle may be configured to open and close a covering for the battery compartment to allow access to the battery compartment from outside the electric vehicle. In some embodiments, the autonomous battery vehicle may be configured to open and close a covering for the battery compartment to allow access to the battery compartment from outside the electric vehicle. Once the spent battery has exited the battery compartment, the propulsion system of the autonomous battery vehicle may maneuver into the battery compartment.

In block 514, the autonomous battery vehicle processor may control the battery (e.g., battery 230) to provide electricity to the electric vehicle. For example, the autonomous battery vehicle processor may control the battery (e.g., battery 230) to provide electricity to the electric vehicle to power the electric vehicle during operation of the electric vehicle. In response to the autonomous battery vehicle being inside the battery compartment, the battery may provide electricity to the electric vehicle. In some embodiments, the autonomous battery vehicle may connect to the electric vehicle via one or more connectors (e.g., 312) or other type physical coupling (e.g., connection plates, plugs, tabs, etc.) and/or via one or more non-physical couplings (e.g., conductive connections, inductive connections, etc.) to provide electricity to the electric vehicle. In some embodiments, electricity may be provided directly from the battery of the autonomous battery vehicle to an engine of the electric vehicle and/or electricity may be provided to another battery of the electric vehicle.

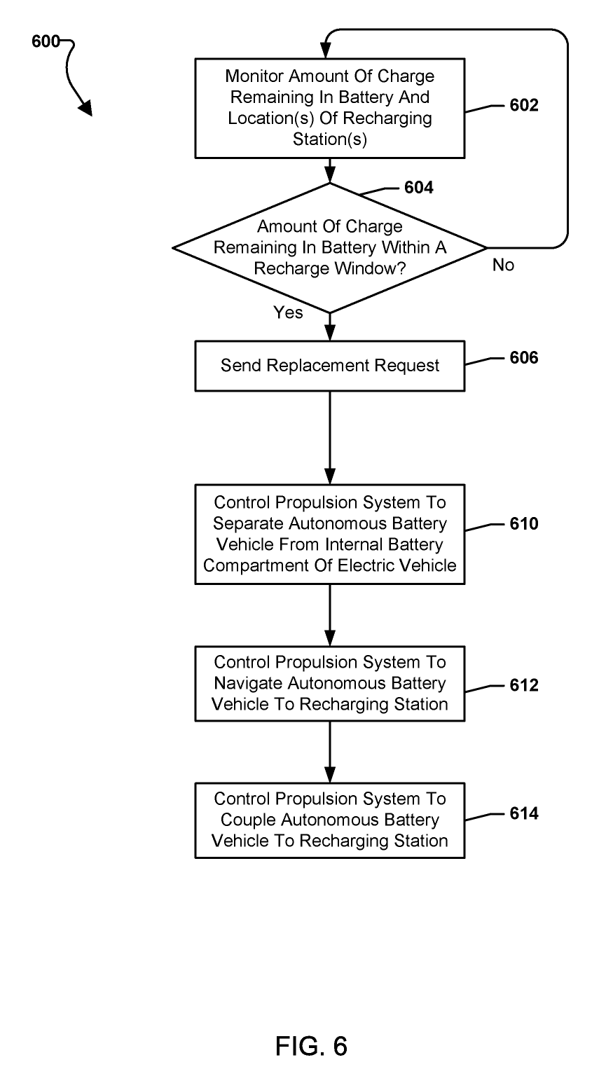

FIG. 6 illustrates a method 600 for recharging an autonomous battery vehicle according to some embodiments. With reference to FIGS. 1-6, the method 600 may be implemented in hardware components and/or software components of an autonomous battery vehicle (e.g., autonomous battery vehicle 104, 106), the operation of which may be controlled by one or more processors (e.g., the processor 220 and/or the like) of the autonomous battery vehicle. In some embodiments, the operations of the method 600 may be performed in conjunction with the operations of the method 500.

In block 602, the autonomous battery vehicle processor may monitor an amount of charge in the battery (e.g., battery 230) and locations of recharging stations (e.g., recharging station 108). In some embodiments, the processor may be configured to monitor the battery, for example to determine an amount of charge remaining in the battery at a given time. In some embodiments, the autonomous battery vehicle currently within the electric vehicle may monitor the locations of one or more recharging stations. As an example, the autonomous battery vehicle may communicate with a recharging network and receive location information (e.g., GPS coordinates, etc.) for one or more recharging station in the recharging network and may determine distances from the autonomous battery vehicle's current location to the one or more recharging station locations.

In determination block 604, the autonomous battery vehicle processor may determine whether an amount of charge remaining in the battery of the autonomous battery vehicle is within a recharge window. A recharge window may be an amount of charge remaining in the battery of the autonomous battery vehicle sufficient to enable the propulsion system to navigate the autonomous battery vehicle to a recharging station. The autonomous battery vehicle may estimate the amount of energy needed to travel the distance to a closest recharging station and may set the recharge window as equal to that estimated state of charge needed to provide the energy needed to travel the distance to the closest recharging station plus an additional safety margin charge. The additional safety margin charge may be based on an amount of energy needed to transit the distance to the closest recharging station plus the amount of energy to power the electric vehicle until a replacement autonomous vehicle arrives, plus some additional margin such as an additional five or ten percent for example.

In response to determining that the amount of charge in the battery remains above the recharge window (i.e., determination block 604=“No”), the autonomous battery vehicle processor may continue to monitor the battery charge in block 602.

In response to determining that the amount of charge in the battery has reached or is within the recharge window (i.e., determination block 604=“Yes”), the autonomous battery vehicle processor may send a replacement request in block 606. The autonomous battery vehicle currently within an electric vehicle may request the another autonomous battery vehicle directly by communications with the recharging network and/or via communications through the electric vehicle. The replacement request may be sent to another autonomous battery vehicle or may be sent to a recharging system server. The replacement request may be a message indicating that an electric vehicle (e.g., 102) internal battery is in need of charging. A replacement request may identify the electric vehicle in need of charging, identify an autonomous battery vehicle in need of replacement (swap-out), and/or identify the location of the electric vehicle.

In block 610, the autonomous battery vehicle processor may control the propulsion system to separate the autonomous battery vehicle from the internal battery compartment of the electric vehicle (e.g., electric vehicle 102). For example, the autonomous battery vehicle's propulsion system may fly or drive the autonomous battery vehicle out of the battery compartment and away from the electric vehicle, thereby decoupling the autonomous battery vehicle. In some embodiments, the autonomous battery vehicle processor may control the propulsion system to separate (or decouple) the autonomous battery vehicle in response to another autonomous battery vehicle initiating (or triggering) replacement (e.g., being in proximity to the electric vehicle, triggering replacement by communications between the autonomous battery vehicles, etc.).

In block 612, the autonomous battery vehicle may control the propulsion system to navigate to a recharging station. For example, the autonomous battery vehicle processor may control the motors of the autonomous battery vehicle to fly or drive the autonomous battery vehicle to the location of the nearest recharging station.

In block 614, the autonomous battery vehicle may control the propulsion system to couple the autonomous battery vehicle to a recharging station. For example, the autonomous battery vehicle processor may control the motors of the autonomous battery vehicle to fly or drive the autonomous battery vehicle onto a charging pad of the recharging station. In some embodiments, in response to coupling to the recharging station, the autonomous battery vehicle processor may perform operations of method 500 to charge the battery of the autonomous battery vehicle.

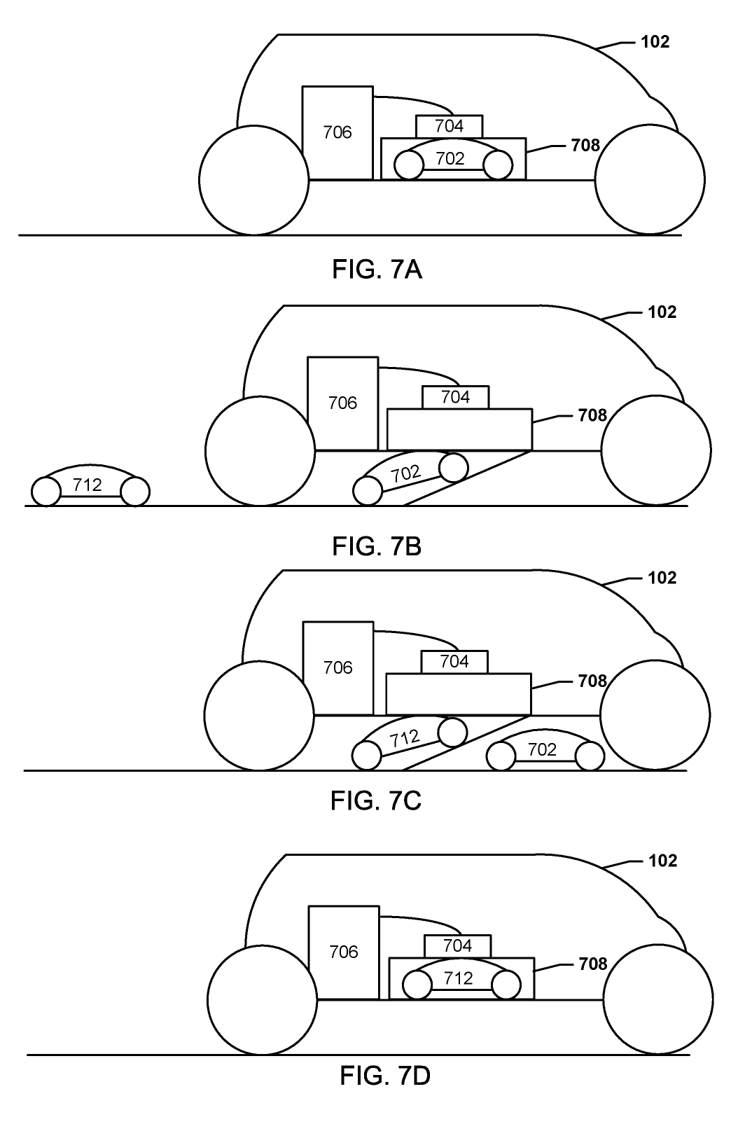

FIGS. 7A-7D illustrate replacement of an internal battery 702 of an electric vehicle 102 in need of charging with a terrestrial autonomous battery vehicle 712 according to some embodiments. With reference to FIGS. 1-7D, the electric vehicle 102 may include a battery compartment 708, a charging connector 704, and an electric motor 706. The charging connector 704 may be connected to the motor 706. The motor 706 may include an additional internal battery in some embodiments. The charging connector 704 may enable a battery (e.g., battery 230) of an autonomous battery vehicle 702, 712 (e.g., autonomous battery vehicle 106) in the battery compartment 708 to connect to the motor 706 (or an internal battery of the motor 706) to provide electrical charge to the motor 706 (or an internal battery of the motor 706). The charging connector 704 may be a physical coupling connector (e.g., connection plate, plug, tab, etc.) and/or may be a non-physical coupling connector (e.g., conductive coil, inductive coil, etc.) that enables a connection between the autonomous battery vehicle 702, 712 (e.g., autonomous battery vehicle 106) in the battery compartment 708 to the motor 706 (or an internal battery of the motor 706). The replacement of the internal battery 702 of the electric vehicle 102 in need of charging with the terrestrial autonomous battery vehicle 712 may be performed according to the operations of methods 500 and/or 600. The electric vehicle 102 in FIGS. 7A-7D may be moving (e.g., driving on a highway) or may be stationary (e.g., parked in a parking lot).

FIG. 7A illustrates an initial time when the autonomous battery vehicle 702 may be providing a charge to the electric vehicle 102. The autonomous battery vehicle 702 may send a replacement request. In response to the replacement request, another autonomous battery vehicle 712 may navigate (e.g., drive) to the electric vehicle 102 as illustrated in FIG. 7B. Additionally, the autonomous battery vehicle 702 may exit the battery compartment 708. For example, the autonomous battery vehicle 702 may drive down a ramp created by the opening of the battery compartment 708 cover. The opening of the battery compartment 708 may be triggered by communications from one or both of the autonomous battery vehicles 702, 712. While the autonomous battery vehicle 702 is exiting the battery compartment 708, the electric vehicle motor 706 may continue to operate off an internal battery or may not be capable of operation in some embodiments.

FIG. 7C illustrates that upon the exit of autonomous battery vehicle 702 from the battery compartment 708, the autonomous battery vehicle 712 may replace the autonomous battery vehicle 702 in need of charging by driving up the ramp into the battery compartment 708. The autonomous battery vehicle 712 may couple to the charging connector 704 and autonomous battery vehicle 702 may navigate away from the electric vehicle 102, for example to a recharging station (e.g., recharging station 108). As illustrated in FIG. 7D, the autonomous battery vehicle 712 may be internal to the electric vehicle 102 in the battery compartment 708 and may provide electricity to the motor 706 via the electrical connector 704.

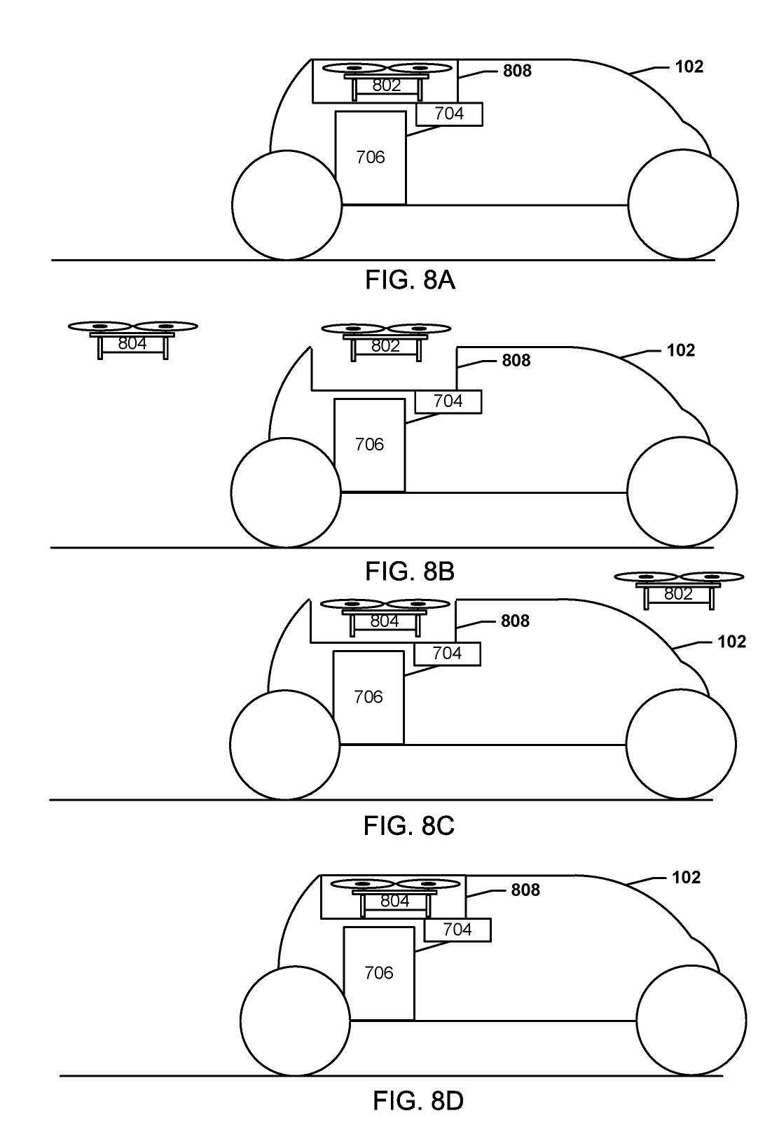

FIGS. 8A-8D illustrate replacement of an internal battery 802 of an electric vehicle 102 in need of charging with an aerial autonomous battery vehicle 804 according to some embodiments. With reference to FIGS. 1-8D, the electric vehicle 102 may include a battery compartment 808, a charging connector 704, and an electric motor 706. The charging connector 704 may be connected to the motor 706. The motor 706 may include an additional internal battery in some embodiments. The charging connector 704 may enable a battery (e.g., 230, 310) of an autonomous battery vehicle 802, 804 (e.g., autonomous battery vehicle 104) in the battery compartment 808 to connect to the motor 706 (or an internal battery of the motor 706) to provide electrical charge to the motor 706 (or an internal battery of the motor 706). The charging connector 704 may be a physical coupling connector (e.g., connection plate, plug, tab, etc.) and/or may be a non-physical coupling connector (e.g., conductive coil, inductive coil, etc.) that enables a connection between the autonomous battery vehicle 802, 804 (e.g., autonomous battery vehicle 104) in the battery compartment 808 to the motor 706 (or an internal battery of the motor 706). The replacement of the internal battery 702 of the electric vehicle 102 in need of charging with the aerial autonomous battery vehicle 804 may be performed according to the operations of methods 500 and/or 600. The electric vehicle 102 in FIGS. 8A-8D may be moving (e.g., driving on a highway) or may be stationary (e.g., parked in a parking lot).

FIG. 8A illustrates an initial time when the autonomous battery vehicle 802 may be providing a charge to the electric vehicle 102. The autonomous battery vehicle 802 may send a replacement request. In response to the replacement request, another autonomous battery vehicle 804 may navigate (e.g., fly) to the electric vehicle 102 as illustrated in FIG. 8B. Additionally, the autonomous battery vehicle 802 may exit the battery compartment 808. For example, the autonomous battery vehicle 802 may fly out of the opening created by the opening of the battery compartment 808 cover. The opening of the battery compartment 808 may be triggered by communications from one or both of the autonomous battery vehicles 802, 804. While the autonomous battery vehicle 802 is exiting the battery compartment 808, the electric vehicle motor 706 may continue to operate off an internal battery or may not be capable of operation in some embodiments.

FIG. 8C illustrates that upon the exit of autonomous battery vehicle 802 from the battery compartment 808, the autonomous battery vehicle 804 may replace the autonomous battery vehicle 802 in need of charging by landing in the battery compartment 808. The autonomous battery vehicle 804 may couple to the charging connector 704 and autonomous battery vehicle 702 may navigate away from the electric vehicle 102, for example to a recharging station (e.g., recharging station 108). As illustrated in FIG. 8D, the autonomous battery vehicle 804 may be internal to the electric vehicle 102 in the battery compartment 808 and may provide electricity to the motor 706 via the electrical connector 704.

While aerial and terrestrial autonomous battery vehicles are shown replacing like type autonomous battery vehicles in FIGS. 7A-8D, in some embodiments aerial autonomous battery vehicles may replace (or swap-out with) terrestrial battery vehicles.

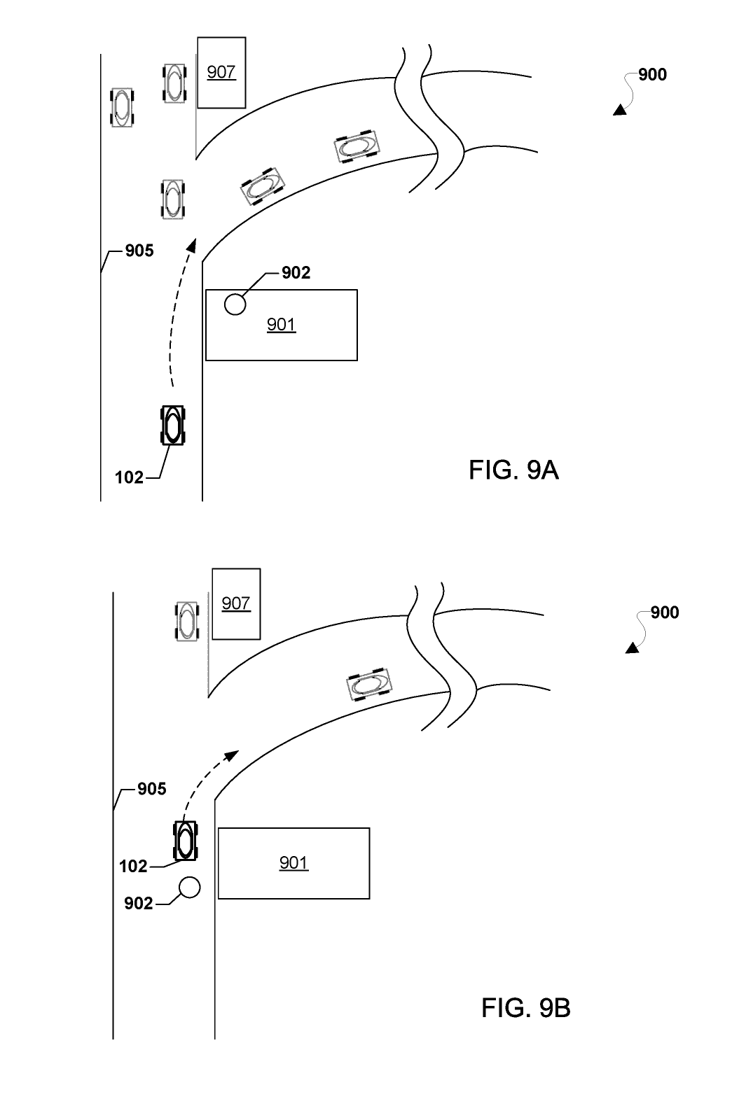

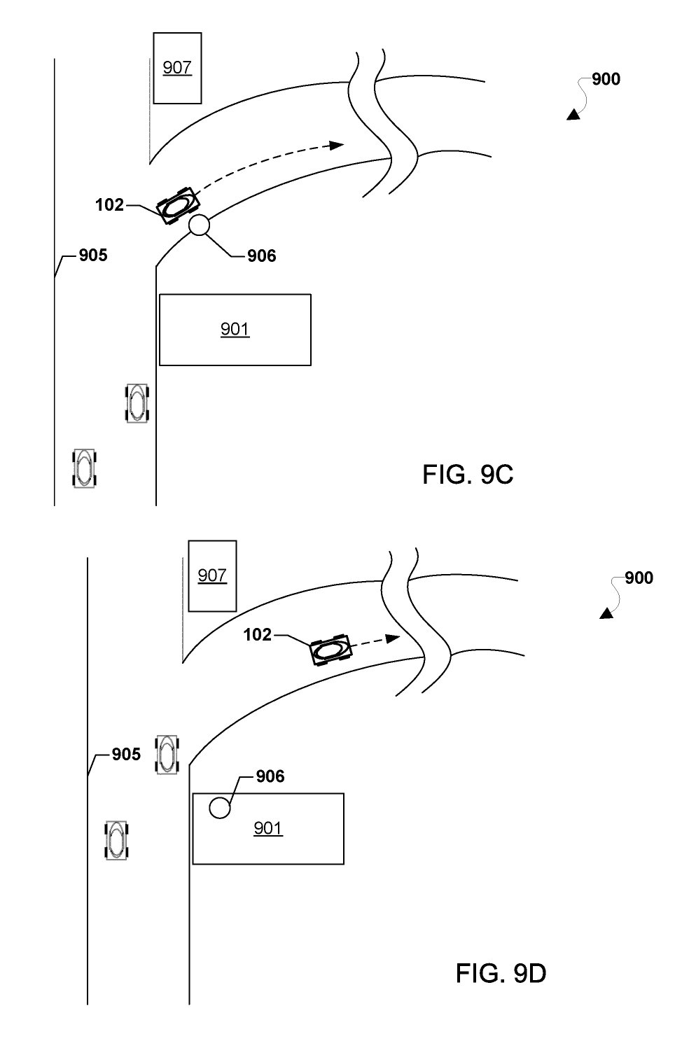

FIGS. 9A-9D illustrates an example of recharging an autonomous battery vehicle 906 according to some embodiments. With reference to FIGS. 1-9D, the operating environment 900 for a recharging system may be on a highway 905 with multiple recharging stations 901, 907 (e.g., similar to recharging station 108) and multiple vehicles, including electric vehicle 102. FIG. 9A illustrates an initial time at which the electric vehicle 102 may be traveling on the highway 905 and the battery of the electric vehicle 102 may be in need of charging. The electric vehicle 102 may be closest to recharging station 901 at which autonomous battery vehicle 902 (e.g., similar to autonomous battery vehicle 104 or 106) may be docked. A recharge request (e.g., from the electric vehicle 102 directly or from a recharging system server (e.g., recharging system server 114)) may activate the autonomous battery vehicle 902 as it may be the closest autonomous battery vehicle 902 at the closest recharging station 901 to the electric vehicle 102.

As illustrated in FIG. 9B, the autonomous battery vehicle 902 may navigate to the electric vehicle 102. The autonomous battery vehicle 902 may fly or drive to the electric vehicle 102 and rendezvous with the electric vehicle at its new current location. The autonomous battery vehicle 902 may replace (or swap-out with) autonomous battery vehicle 906 (e.g., autonomous battery vehicle 104, 106) which had been providing a charge to electric vehicle 102. As illustrated in FIG. 9C, autonomous battery vehicle 906 may navigate (e.g., drive or fly) away from the electric vehicle 102 toward a recharging station 901 (e.g., the closest recharging station). In FIG. 9D, the autonomous battery vehicle 906 is shown docked at the recharging station 901 and the electric vehicle 102 is proceeding down the highway 905 now being powered by autonomous battery vehicle 902.

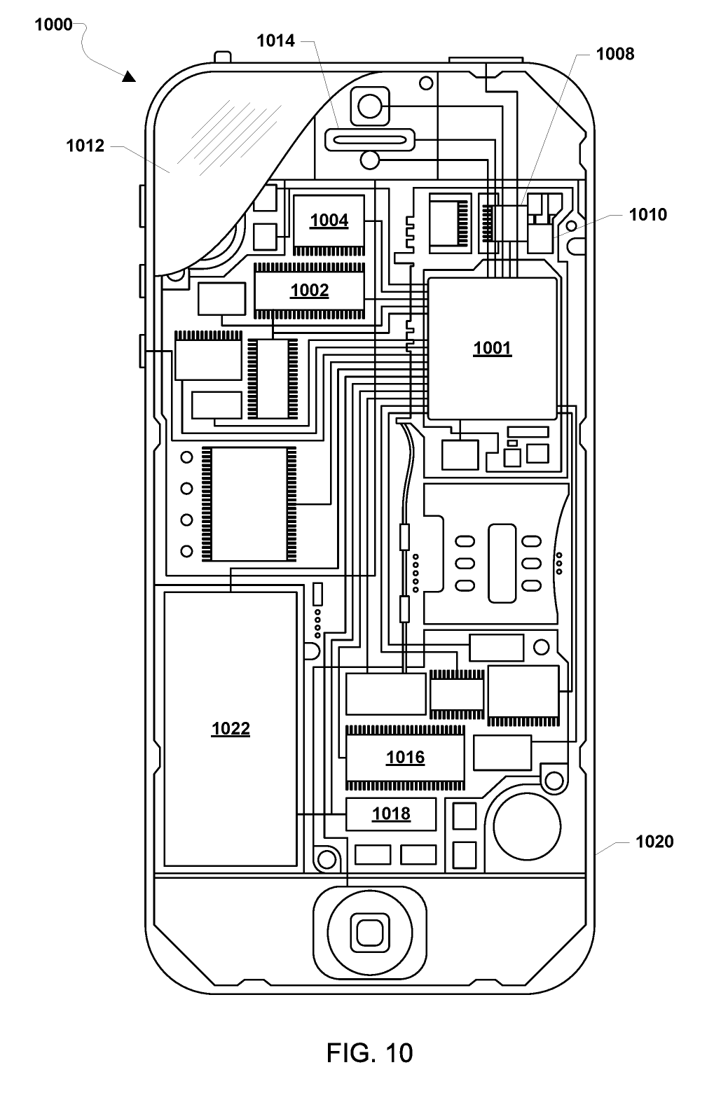

Various embodiments (including, but not limited to, embodiments discussed above with reference to FIGS. 1-9D) may be implemented in any of a variety of the computing devices including a mobile device 1000, an example of which is illustrated in FIG. 10. As such, the mobile device 1000 may implement the methods 500 and/or 600 in FIGS. 5 and/or 6. With reference to FIGS. 1-10, for example, the mobile device 1000 may include a processor 1001 coupled to a touch screen controller 1004 and an internal memory 1002. The processor 1001 may be one or more multicore integrated circuits (ICs) designated for general or specific processing tasks. The internal memory 1002 may be volatile or non-volatile memory, and may also be secure and/or encrypted memory, or unsecure and/or unencrypted memory, or any combination thereof. The touch screen controller 1004 and the processor 1001 may also be coupled to a touch screen panel 1012, such as a resistive-sensing touch screen, capacitive-sensing touch screen, infrared sensing touch screen, etc.

The mobile device 1000 may have one or more radio signal transceivers 1008 (e.g., Peanut®, Bluetooth®, Zigbee®, Wi-Fi, RF, cellular, etc.) and antennae 1010, for sending and receiving, coupled to each other and/or to the processor 1001. The transceivers 1008 and antennae 1010 may be used with the above-mentioned circuitry to implement various wireless transmission protocol stacks and interfaces and to establish the various wireless links discussed herein. The mobile device 1000 may include one or more cellular network wireless modem chips 1016, such as one cellular network wireless modem chip, two cellular network wireless modem chips, three cellular network wireless modem chips, four cellular network wireless modem chips, or more than four cellular network wireless modem chips, that enables communication via one or more cellular networks and that are coupled to the processor 1001. The one or more cellular network wireless modem chips 1016 may enable the mobile device 1000 to receive services from one or more cellular networks (e.g., CDMA, TDMA, GSM, 3G, 4G, LTE, or any other type of cellular network), to implement various wireless transmission protocol stacks and interfaces, and to establish the various wireless links discussed herein.

The mobile device 1000 may include a peripheral device connection interface 1018 coupled to the processor 1001. The peripheral device connection interface 1018 may be singularly configured to accept one type of connection, or multiply configured to accept various types of physical and communication connections, common or proprietary, such as USB, FireWire, Thunderbolt, Ethernet, or PCIe. The peripheral device connection interface 1018 may also be coupled to a similarly configured peripheral device connection port (not shown). The mobile device 1000 may also include speakers 1014 for providing audio outputs.

The mobile device 1000 may also include a housing 1020, constructed of a plastic, metal, or a combination of materials, for containing all or some of the components discussed herein. The mobile device 1000 may include a power source 1022 coupled to the processor 1001, such as a disposable or rechargeable battery. The rechargeable battery may also be coupled to the peripheral device connection port to receive a charging current from a source external to the mobile device 1000.

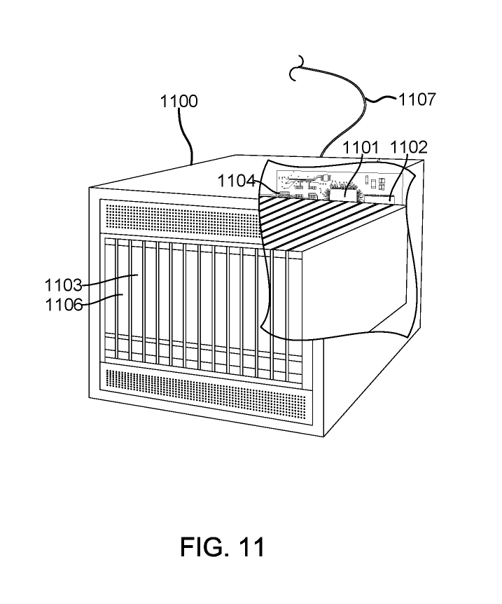

Various embodiments (including, but not limited to, embodiments discussed above with reference to FIGS. 1-9D) may be implemented in any of a variety of the computing devices including a server 1100 (e.g., recharging system server 114), an example of which is illustrated in FIG. 11. As such, server 1100 may implement the methods 500 and/or 600 in FIGS. 5 and/or 6. With reference to FIGS. 1-11, such a server 1100 typically includes a processor 1101 coupled to volatile memory 1102 and a large capacity nonvolatile memory, such as a disk drive 1104. The server 1100 may also include a floppy disc drive, compact disc (CD) or DVD disc drive 1106 coupled to the processor 1101. The server 1100 may also include one or more wired or wireless network transceivers 1103, such one or more network access ports and/or wired or wireless modems (e.g., one wireless modem, two wireless modems, three wireless modems, four wireless modems, or more than four wireless modems), coupled to the processor 1101 for establishing network interface connections with one or more communication networks 1107, such as a local area network (e.g., Ethernet, etc.) coupled to other computing devices and/or servers, the Internet, the public switched telephone network, and/or one or more cellular networks (e.g., CDMA, TDMA, GSM, PCS, 3G, 4G, LTE, or any other type of cellular network).

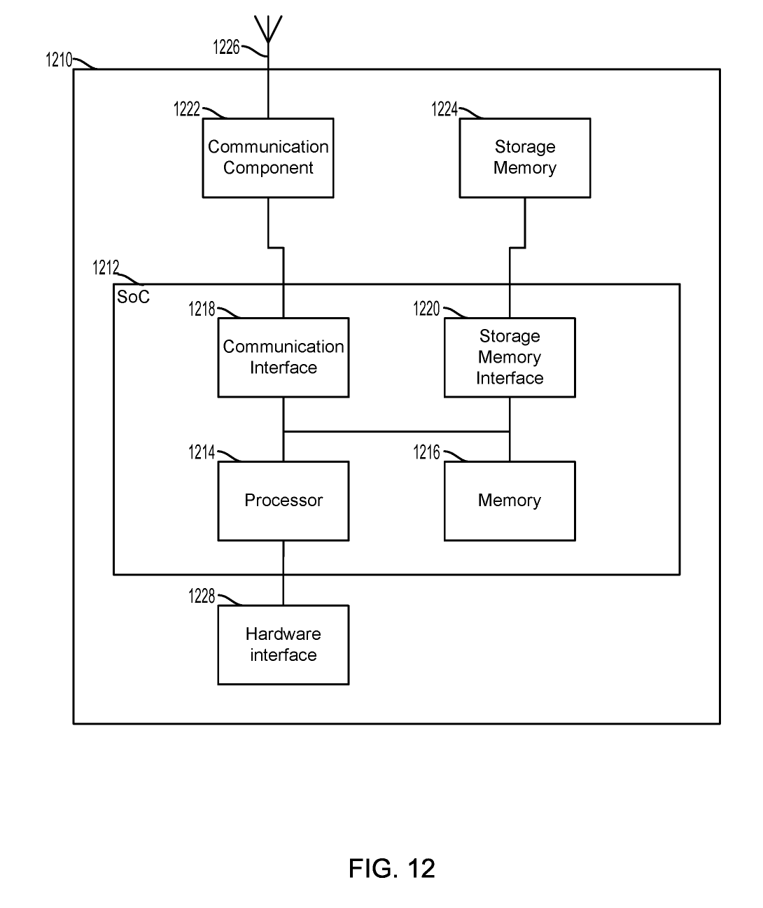

Various embodiments (including, but not limited to, embodiments discussed with reference to FIGS. 1-9D) may be implemented within a processing device 1210 configured to be used in an autonomous battery vehicle (e.g., autonomous battery vehicles 104, 106). As such, the processing device 1210 may implement the methods 500 and/or 600 in FIGS. 5 and/or 6. A processing device may be configured as or including a system-on-chip (SoC) 1212, an example of which is illustrated FIG. 12. With reference to FIGS. 1-12, the SoC 1212 may include (but is not limited to) a processor 1214, a memory 1216, a communication interface 1218, and a storage memory interface 1220. The processing device 1210 or the SoC 1212 may further include a communication component 1222, such as a wired or wireless modem, a storage memory 1224, an antenna 1226 for establishing a wireless communication link, and/or the like. The processing device 1210 or the SoC 1212 may further include a hardware interface 1228 configured to enable the processor 1214 to communicate with and control various components of a autonomous battery vehicle. The processor 1214 may include any of a variety of processing devices, for example any number of processor cores.

The terms “system-on-chip” and SoC are used herein to refer to a set of interconnected electronic circuits typically, but not exclusively, including one or more processors (e.g., 1214), a memory (e.g., 1216), and a communication interface (e.g., 1218). The SoC 1212 may include a variety of different types of processors 1214 and processor cores, such as a general purpose processor, a central processing unit (CPU), a digital signal processor (DSP), a graphics processing unit (GPU), an accelerated processing unit (APU), a subsystem processor of specific components of the processing device, such as an image processor for a camera subsystem or a display processor for a display, an auxiliary processor, a single-core processor, and a multicore processor. The SoC 1212 may further embody other hardware and hardware combinations, such as a field programmable gate array (FPGA), an application-specific integrated circuit (ASIC), other programmable logic device, discrete gate logic, transistor logic, performance monitoring hardware, watchdog hardware, and time references. Integrated circuits may be configured such that the components of the integrated circuit reside on a single piece of semiconductor material, such as silicon.

The SoC 1212 may include one or more processors 1214. The processing device 1210 may include more than one SoC 1212, thereby increasing the number of processors 1214 and processor cores. The processing device 1210 may also include processors 1214 that are not associated with an SoC 1212 (i.e., external to the SoC 1212). Individual processors 1214 may be multicore processors. The processors 1214 may each be configured for specific purposes that may be the same as or different from other processors 1214 of the processing device 1210 or SoC 1212. One or more of the processors 1214 and processor cores of the same or different configurations may be grouped together. A group of processors 1214 or processor cores may be referred to as a multi-processor cluster.

The memory 1216 of the SoC 1212 may be a volatile or non-volatile memory configured for storing data and processor-executable instructions for access by the processor 1214. The processing device 1210 and/or SoC 1212 may include one or more memories 1216 configured for various purposes. One or more memories 1216 may include volatile memories such as random access memory (RAM) or main memory, or cache memory.

Some or all of the components of the processing device 1210 and the SoC 1212 may be arranged differently and/or combined while still serving the functions of various embodiments. The processing device 1210 and the SoC 1212 may not be limited to one of each of the components, and multiple instances of each component may be included in various configurations of the processing device 1210.

The processors 220, 1001, 1101, and 1214 may be any programmable microprocessor, microcomputer or multiple processor chip or chips that can be configured by software instructions (applications) to perform a variety of functions, including the functions of various embodiments described above. In some devices, multiple processors may be provided, such as one processor dedicated to wireless communication functions and one processor dedicated to running other applications. Typically, software applications may be stored in the internal memory before they are accessed and loaded into the processors 220, 220, 1001, 1101, and 1214. The processors 220, 1001, 1101, and 1214 may include internal memory sufficient to store the application software instructions. In many devices, the internal memory may be a volatile or nonvolatile memory, such as flash memory, or a mixture of both. For the purposes of this description, a general reference to memory refers to memory accessible by the processors 220, 1001, 1101, and 1214 including internal memory or removable memory plugged into the device and memory within the processors 220, 1001, 1101, and 1214 themselves.

Various embodiments illustrated and described are provided merely as examples to illustrate various features of the claims. However, features shown and described with respect to any given embodiment are not necessarily limited to the associated embodiment and may be used or combined with other embodiments that are shown and described. Further, the claims are not intended to be limited by any one example embodiment. For example, one or more of the operations of the methods 500 and 600 may be substituted for or combined with one or more operations of the methods 500 and 600, and vice versa.

The foregoing method descriptions and the process flow diagrams are provided merely as illustrative examples and are not intended to require or imply that the operations of various embodiments must be performed in the order presented. As will be appreciated by one of skill in the art the order of operations in the foregoing embodiments may be performed in any order. Words such as “thereafter,” “then,” “next,” etc. are not intended to limit the order of the steps; these words are simply used to guide the reader through the description of the methods. Further, any reference to claim elements in the singular, for example, using the articles “a,” “an” or “the” is not to be construed as limiting the element to the singular.

The various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the claims.

The hardware used to implement the various illustrative logics, logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Alternatively, some steps or methods may be performed by circuitry that is specific to a given function.

In various embodiments, the functions described may be implemented in hardware, software, firmware, or any combination thereof. If implemented in software, the functions may be stored as one or more instructions or code on a non-transitory computer-readable medium or non-transitory processor-readable medium. The operations of a method or algorithm disclosed herein may be embodied in a processor-executable software module, which may reside on a non-transitory computer-readable or processor-readable storage medium. Non-transitory server-readable, computer-readable or processor-readable storage media may be any storage media that may be accessed by a computer or a processor. By way of example but not limitation, such non-transitory server-readable, computer-readable or processor-readable media may include RAM, ROM, EEPROM, FLASH memory, CD-ROM or other optical disk storage, magnetic disk storage or other magnetic storage devices, or any other medium that may be used to store desired program code in the form of instructions or data structures and that may be accessed by a computer. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the above are also included within the scope of non-transitory server-readable, computer-readable and processor-readable media. Additionally, the operations of a method or algorithm may reside as one or any combination or set of codes and/or instructions on a non-transitory server-readable, processor-readable medium and/or computer-readable medium, which may be incorporated into a computer program product.

The preceding description of the disclosed embodiments is provided to enable any person skilled in the art to make or use the claims. Various modifications to these embodiments will be readily apparent to those skilled in the art, and the generic principles defined herein may be applied to other embodiments without departing from the scope of the claims. Thus, the claims are not intended to be limited to the embodiments described herein but are to be accorded the widest scope consistent with the following claims and the principles and novel features disclosed herein.

What is claimed is:

1. An autonomous battery vehicle, comprising:
a battery;
a propulsion system connected to the battery; and
a processor connected to the battery and the propulsion system, wherein the processor is configured to:
control the propulsion system to navigate the autonomous battery vehicle to an electric vehicle;
control the propulsion system to replace a first battery of the electric vehicle with the autonomous battery vehicle; and
control the battery to provide electricity to the electric vehicle.

2. The autonomous battery vehicle of claim 1, wherein the autonomous battery vehicle is configured to replace the first battery of the electric vehicle while the electric vehicle is moving or while the electric vehicle is stationary.

3. The autonomous battery vehicle of claim 1, wherein the autonomous battery vehicle is an aerial autonomous battery vehicle or a terrestrial autonomous battery vehicle.

4. The autonomous battery vehicle of claim 1, wherein the processor is further configured to:
determine whether an amount of charge remaining in the battery is within a recharge window; and
request another autonomous battery vehicle to replace the autonomous battery vehicle in the electric vehicle in response to determining that the amount of charge remaining in the battery is within the recharge window,
wherein the recharge window is an amount of charge remaining in the battery sufficient to enable the propulsion system to navigate the autonomous battery vehicle to a recharging station.

5. The autonomous battery vehicle of claim 1, wherein the first battery of the electric vehicle comprises another autonomous battery vehicle.

6. The autonomous battery vehicle of claim 1, wherein the processor is further configured to control the propulsion system to decouple the autonomous battery vehicle from the electric vehicle in response to replacement by another autonomous battery vehicle being initiated.

7. A method for charging an electric vehicle, comprising:
controlling, by a processor of an autonomous battery vehicle, a propulsion system of the autonomous battery vehicle to navigate the autonomous battery vehicle to an electric vehicle;
controlling, by the processor of the autonomous battery vehicle, the propulsion system to replace a first battery of the electric vehicle with the autonomous battery vehicle; and
controlling, by the processor of the autonomous battery vehicle, a battery of the autonomous battery vehicle to provide electricity to the electric vehicle.

8. The method of claim 7, wherein replacement of the first battery of the electric vehicle occurs while the electric vehicle is moving or stationary.

9. The method of claim 7, wherein the autonomous battery vehicle is one of an aerial autonomous battery vehicle or a terrestrial autonomous battery vehicle.

10. The method of claim 7, further comprising:
determining, by the processor of the autonomous battery vehicle, whether an amount of charge remaining in the battery is within a recharge window; and
requesting, by the processor of the autonomous battery vehicle, another autonomous battery vehicle to replace the autonomous battery vehicle in the electric vehicle in response to determining that the amount of charge remaining in the battery is within the recharge window,
wherein the recharge window is an amount of charge remaining in the battery sufficient to enable the propulsion system to navigate the autonomous battery vehicle to a recharging station.

11. The method of claim 7, wherein the first battery of the electric vehicle comprises another autonomous battery vehicle.

12. The method of claim 7, further comprising controlling, by the processor of the autonomous battery vehicle, the propulsion system to decouple the autonomous battery vehicle from the electric vehicle in response to replacement by another autonomous battery vehicle being initiated.

13. A processing device configured for use in an autonomous battery vehicle and configured to:
a control a propulsion system of the autonomous battery vehicle to navigate the autonomous battery vehicle to an electric vehicle;
control the propulsion system to replace a first battery of the electric vehicle with the autonomous battery vehicle; and
control a battery of the autonomous battery vehicle to provide electricity to the electric vehicle.

14. The processing device of claim 13, wherein the autonomous battery vehicle is configured to replace the first battery of the electric vehicle while the electric vehicle is moving or while the electric vehicle is stationary.

15. The processing device of claim 13, wherein the autonomous battery vehicle is an aerial autonomous battery vehicle or a terrestrial autonomous battery vehicle.

16. The processing device of claim 13, wherein the processing device is further configured to:
determine whether an amount of charge remaining in the battery is within a recharge window; and
request another autonomous battery vehicle to replace the autonomous battery vehicle in the electric vehicle in response to determining that the amount of charge remaining in the battery is within the recharge window,
wherein the recharge window is an amount of charge remaining in the battery sufficient to enable the propulsion system to navigate the autonomous battery vehicle to a recharging station.

17. The processing device of claim 13, wherein the first battery of the electric vehicle comprises another autonomous battery vehicle.

18. The processing device of claim 13, wherein the processing device is further configured to control the propulsion system to decouple the autonomous battery vehicle from the electric vehicle in response to replacement by another autonomous battery vehicle being initiated.
